(19) United States
(12) Patent Application Publication
(10) Pub. No.: US 2010/0205877 A1
(43) Pub. Date: Aug. 19, 2010

(54) Mounting system for securing a photovoltaic device and method for its use

(76) Inventors: Uday Varde, West Bloomfield, MI (US); Jonathan Call, Royal Oak, MI (US); Subhendu Guha, Bloomfield Hills, MI (US)

Correspondence Address: ENERGY CONVERSION DEVICES, INC., 2956 WATERVIEW DRIVE, ROCHESTER HILLS, MI, 48309, US

(21) Appl. No.: 12/378,310

(22) Filed: Feb. 13, 2009

(51) Int. Cl. E04D 13/18; B23P 11/00; E04B 1/38; E04C 2/20

(52) U.S. Cl. 52/173.3; 29/428; 52/698; 52/309.5

(57) ABSTRACT

A mounting system for securing a photovoltaic device to a surface is provided in accordance with an exemplary embodiment. The mounting system includes one or more mounting members for securing an inactive area of the photovoltaic device to the surface. The mounting members are configured so the inactive area is non-destructively detachable from the surface and the photovoltaic device is not made incapable of operation due the detachment process. In an exemplary embodiment, the mounting system includes a unique configuration of mounting members for securing the photovoltaic device against the surface during a predetermined load condition imposed upon the photovoltaic device.

### GOVERNMENT INTEREST

This invention was made, at least in part, under U.S. Government, Department of Energy, Contract No. DE-FC36-07G017053. The Government may have rights in this invention.

### FIELD OF THE INVENTION

This invention relates generally to securing a photovoltaic device. More particularly, the invention relates to a mounting system for securing a photovoltaic device, wherein the mounting system is also configured so the photovoltaic device is non-destructively detachable.

### BACKGROUND OF THE INVENTION

Installation of photovoltaic devices onto commercial and residential structures has recently become more affordable and desirable for generation of electrical energy. Additionally, photovoltaic device design has evolved to become less bulky and cumbersome to install onto the structures. For example, a photovoltaic device can now be supplied as a roll of flexible thin film that can be unrolled and installed onto a structural surface that can have a substantially flat area, a generally planar configuration formed with structural members, particles or a coating, or a curvature that accommodates operation of the installed photovoltaic device.

It is desirable to install a photovoltaic device in a simple and quick manner. Some photovoltaic device installations involve a rigid frame that is joined with the photovoltaic device or otherwise utilized to mount the photovoltaic device onto a structure, for example a roof of a building or house. Typically, the frame is secured by penetrating the structure (e.g. drilling holes) so the frame can be bolted or screwed to the structure. In other applications, the photovoltaic device itself may be configured such that a portion of it is screwed or bolted directly to the structure.

These types of installations may allow entry into the structure of environmental elements such as water, insects, wind, etc. Additionally, the installations generally require more components to secure the photovoltaic device to the structure, thereby increasing the cost of installing the photovoltaic device. The photovoltaic device installations discussed above are likely not capable of being installed and operated again because they are more likely to experience damage during disassembly. Moreover, removal of a photovoltaic device secured by penetrating the structure will likely involve repair to the structure after the photovoltaic device is removed. For example, a knife may be used to quickly remove a section of material secured to a roof surface, but that process severely damages the material and is likely to result in damage to the roof surface.

The installation configuration of the photovoltaic device may also be dictated by the configuration of the particular structure, environmental conditions at the structure, and or building codes particular to the location of the structure. Many commercial and residential building codes require that structure, and objects mounted to the structure such as photovoltaic devices, withstand predetermined loads such as weight, winds, and jarring loads (e.g. caused by an earthquake) without detrimental effects to the structure and to other nearby property or persons.

Therefore, the inventors herein have recognized a need for a mounting system configured for securing a photovoltaic device to structure, wherein the mounting system is also configured so the photovoltaic device can thereafter be non-destructively detached from the structure and installed and operated again without the need for repairing the photovoltaic device.

### SUMMARY OF THE INVENTION

A mounting system for securing a photovoltaic device to a surface is provided in accordance with an exemplary embodiment. The mounting system includes a mounting member for securing an inactive area of the photovoltaic device to the surface. The mounting member is configured so the inactive area is non-destructively detachable from the surface and the photovoltaic device is not made incapable of operation due the detachment process.

A mounting system for securing a photovoltaic device to a surface is provided in accordance with another exemplary embodiment. The mounting system includes a plurality of spaced ballast members positioned on an inactive area of the photovoltaic device. The ballast members urge the inactive area against the surface. The ballast members are non-destructively detachable from the inactive area and the photovoltaic device is not made incapable of operation due the detachment process.

A method for securing a photovoltaic device to a surface is provided in accordance with another exemplary embodiment. The method includes positioning a mounting member along an unexposed side of a substrate having the photovoltaic device secured to an exposed side of the substrate. The method further includes securing the mounting member to the surface. The mounting member is configured so the substrate is non-destructively detachable from the surface and the photovoltaic device is not made incapable of operation due the detachment process.

### BRIEF DESCRIPTION OF THE DRAWINGS

FIG. 1 is a plan view of a photovoltaic device installation system illustrating a mounting system for securing photovoltaic devices to a surface in accordance with an exemplary embodiment of this disclosure;

FIG. 2 is a cross-sectional view of the photovoltaic device installation system of FIG. 1 along the viewing line 2-2;

FIG. 3 is a cross-sectional view of a photovoltaic device installation system in accordance with an alternative exemplary embodiment of this disclosure;

FIG. 4 is a plan view of a photovoltaic device installation system illustrating an alternative mounting system for securing photovoltaic devices to a surface in accordance with another exemplary embodiment of this disclosure;

FIG. 5 is a plan view of a photovoltaic device installation system illustrating another alternative mounting system for securing photovoltaic devices to a surface in accordance with another exemplary embodiment of this disclosure;

FIG. 6 is a cross-sectional view of the photovoltaic device installation system of FIG. 5 along the viewing line 6-6;

FIG. 7 is a cross-sectional view of a photovoltaic device installation system in accordance with another alternative exemplary embodiment of this disclosure; and

FIG. 8 is a plan view of a photovoltaic device installation system illustrating yet another alternative mounting system for securing photovoltaic devices to a surface in accordance with another exemplary embodiment of this disclosure.

### DETAILED DESCRIPTION OF THE INVENTION

Disclosed herein are embodiments of a mounting system for securing a photovoltaic device against a surface of a structure. Structures contemplated herein include various dwellings such as residential houses, commercial buildings, and shelters. Additionally, it is contemplated that structures used for purposes other than human habitat and configured to accommodate a photovoltaic device installation are within the scope of this disclosure such as but not limited to reservoirs, water tanks, portable structures and covers.

The surface of a structure as contemplated herein can have a generally smooth planar configuration, an irregular surface such as a corrugated panel, a surface formed from a plurality of granular particles like stone or gravel, dirt or a roughened coated surface arranged over an area to form a generally level plane against which the photovoltaic device is mounted thereto. It is contemplated herein the surface upon which the photovoltaic device is mounted thereover includes gravel, earth such as dirt, stones or grass, wherein a substrate is positioned over the surface and beneath the photovoltaic device. In some applications, the photovoltaic device is mounted to a surface that has a radius of curvature that accommodates operation of the photovoltaic device. Non-limiting surface materials contemplated herein are wood, metal, gravel, dirt or earth, various coatings, and polymeric materials, etc.

The embodiments disclosed herein are directed to a mounting system configured so that a minimum of installation tools or no installation tools are utilized to install the photovoltaic device against the surface. The mounting system is also configured to be detached from the surface in a non-destructive manner so that the photovoltaic device can thereafter be installed and operated without the need for repairing the photovoltaic device. In this manner the photovoltaic device mounting system is ideal for residential and commercial applications where one desires to remove a photovoltaic device and thereafter install and operate it at another location without making the photovoltaic device is incapable of operation due the detachment process. A non-destructively detachable photovoltaic device may also be desirable for commercial or military applications, where, for example, a photovoltaic device may be relocated to generate electrical energy for communication devices.

The mounting system is further configured to maintain the photovoltaic device against the surface of a structure subjected to a predetermined load condition. In embodiments, the mounting system can be utilized for photovoltaic device installations having a horizontal or non-horizontal orientation. The mounting system can be configured to maintain the photovoltaic device against the structure during environment conditions, including extreme weather conditions like high winds, storms, earthquakes, etc. In other embodiments, the mounting system is configured to secure a photovoltaic device against a surface having a slope such that the photovoltaic device installation does not displace due to the affect of gravity. It is also contemplated that embodiments of the mounting system can be configured to detachably secure, in a non-destructive manner, a wide variety of photovoltaic devices, including framed and unframed photovoltaic constructions.

In an exemplary embodiment, the mounting system includes at least one mounting member positioned along an unexposed side of a substrate or an inactive area of the photovoltaic device, wherein the mounting member utilizes a detachable interference-fit type fastener capable of repeated engagement. For example, the mounting member is a snap-fit button type fastener. In another instance, the mounting member extends along a length of the substrate and the mounting member is an elongated male portion that engages a complimentary grooved portion with an interference fit upon engagement.

In other embodiments, it is contemplated that the mounting system has a unique arrangement of mounting members for securing the photovoltaic device subjected to a predetermined load condition. For example and in one embodiment of a photovoltaic installation, a portion of the mounting members are configured and positioned along the photovoltaic device to maintain an area of the photovoltaic device against the surface during a certain load condition compared to the remaining mounting members that do not experience the same load condition.

It is contemplated herein that unique arrangements of non-destructively detachable mounting systems for securing photovoltaic devices are possible for a wide variety of installation applications and load conditions. Further, the mounting systems contemplated herein allow for modifying or replacing an arrangement of the mounting system to suit a change in the device design, load condition, locality or photovoltaic installation orientation. For example, a smaller number or otherwise reduced configuration of mounting members may replace the previous mounting system arrangement when the photovoltaic installation is removed from a location of high loading and installed at another location of lower loading, since the mounting system is non-destructively detachable.

In certain embodiments, the mounting systems disclosed herein may be utilized to secure photovoltaic devices against the surface without any intervening material between the photovoltaic device and the surface. In other embodiments, the mounting systems may be configured to secure the photovoltaic device against the surface where another interface or intermediate layer is disposed between the photovoltaic device and the surface or between the photovoltaic device and the inactive area or substrate. In other embodiments, the photovoltaic device is secured to an intermediate layer, substrate or membrane that is detachably secured against the surface. In some embodiments of photovoltaic devices, a substrate or membrane is considered an inactive area of the photovoltaic device and an integral part thereof. In other embodiments, an intermediate layer, such as a coating, is secured to the surface and not intended to be removed when the photovoltaic device is removed. In exemplary embodiments, an interface layer, intermediate layer, membrane, coating, or other member can, as non-limiting examples, be utilized as an insulating layer, a barrier layer or a structural member.

Hereinafter, various exemplary embodiments of mounting systems are described for use with various embodiments of photovoltaic device installations. The elements and members shown in the referenced Figures are not drawn to scale and are shown as such for clarity purposes and not intended to convey limiting information such as shape, orientation, dimensions, weight, etc.

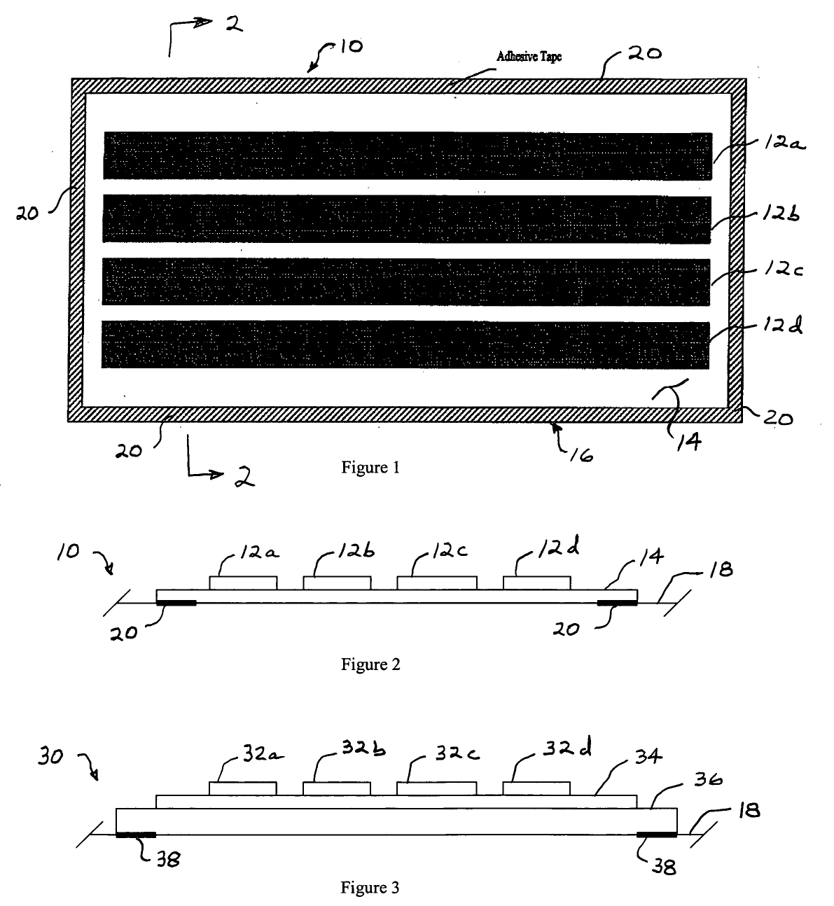

Referring to FIGS. 1 and 2, a photovoltaic installation system 10 is illustrated in accordance with an exemplary embodiment of the present disclosure. The installation system 10 includes a plurality of spaced photovoltaic devices 12a, 12b, 12c, and 12d secured to a substrate 14, and a mounting system 16. The substrate 14 can comprise any material suitable for the particular application, including the environment, the type of photovoltaic devices, and the configuration of the structure the devices are installed onto.

For example, in one embodiment the substrate is a thin membrane such as a cured Ethylene Propylene Diene Monomer (C-EPDM) rubber membrane having a thickness of 0.045 to 0.060 inches commercially available and listed as Standard Rubberguard EPDM II. In another embodiment, the membrane is a Polyvinylchloride (PVC) having a thickness of 0.048 to 0.050 inches commercially available and listed as Sarnafil S327, G410, Johns Manville SR50; or a Thermoplastic Polyolefin (TPO) having a thickness of 0.045 to 0.060 inches commercially available and listed as Genflex White; and a Styrene Butadiene Styrene (SBS) Modified Bituminous multiple-ply with smooth and/or granular surface texture or the like. In other embodiments, the substrate may include a reinforcement material such as but not limited to polyester, glass fiber, or other material or combinations thereof.

The mounting system 16 is configured to secure the photovoltaic devices and the substrate to a surface 18, as shown in FIG. 2. In this embodiment, the mounting system 16 includes an adhesive portion 20 positioned about the perimeter of the substrate 14, as shown in FIG. 1. The adhesive portion 20 is utilized to fixedly secure the substrate 14 to the surface 18. The adhesive portion 20 is further configured so a portion of the substrate is non-destructively detachable from the surface 18 and the photovoltaic devices are not made incapable of operation due to the detachment process. For example, the adhesive portion 20 is a double-sided tape applied to the lower surface of the substrate 14 and the surface 18 to detachably secure the two together. In an alternative embodiment, a heat welding process is utilized to bond the adhesive portion between the substrate and the surface. In an exemplary embodiment, the adhesive portion 20 is a rubberized or butyl composition. An example of such adhesive is commercially available under the designation SikaLastomer®-68 from the Sika Corporation of Madison Heights, Mich.

The adhesive portion is configured so it can be detached from the substrate, intermediate layer, or from an inactive area of the photovoltaic devices in a non-destructive manner and not render the photovoltaic devices inoperable due the detachment process. In one embodiment, when heat is applied to an area of the exposed side of the substrate (generally opposite the adhesive portion), the adhesive portion is configured to degrade so that the substrate can be non-destructively detached from the surface. For example, the substrate is non-destructively detached from the surface by heating a portion of the exposed side of the substrate to 100° C. for approximately five minutes to degrade the adhesive portion so a portion of the substrate or the entire substrate can then be non-destructively detached from the surface with a force of about five pounds.

In another embodiment, an area of the exposed substrate is cooled to a substantially cold temperature, for example utilizing dry ice, to degrade the adhesive portion so a portion of the substrate is non-destructively detachable from the surface without making the photovoltaic device incapable of operation due to the detachment process. An yet in another embodiment, the adhesive portion is configured to degraded when a solution is brought into contact with the adhesive portion so a portion of the substrate is non-destructively detachable from the surface without making the photovoltaic device incapable of operation due to the detachment process.

In the embodiments, the substrate, interface layer, intermediate layer, or inactive area is non-destructively detachable, for example, where they are not severed or punctured in order to detach them from the surface. In other embodiments, slight degradation of the substrate, layer or inactive area may result when detaching them from the surface. The substrate degradation, for example, peeling or cracking, is not to a degree to render the photovoltaic device inoperable.

In some embodiments, once the substrate is moved away from the surface, the adhesive portion is configured so that remaining adhesive can then be substantially removed from the substrate. Degradation and removal of the adhesive may employ such processes as peeling, scraping, or application of a solvent or other solution, heat, cooling or combinations thereof. In some embodiments, the composition of the adhesive and/or the means of degrading the adhesive portion will be such that the substrate will require no further treatment to remove adhesive from the substrate after the process utilized to degrade the adhesive to detach the substrate from the surface. In other embodiments, after degrading the adhesive to detach the substrate from the surface, a texturing process, like sanding, rubbing or the like will be applied to the substrate area of adhesive to enhance a later application of adhesive.

In another exemplary embodiment, the adhesive portion has a two-part configuration where their structural state/composition changes for controlling when adhesive bonding occurs between the parts. A first part of the adhesive is applied to a bottom side (or unexposed side) of the substrate (or inactive area of the photovoltaic device), where at that point the first part of the adhesive is configured to not adhere on contact with certain material, for example, to skin, or to certain packaging material. At installation of the photovoltaic device, the second part of the adhesive is applied to the surface of the structure to which the substrate (or the inactive area) will be secured thereto. In one embodiment, when the substrate is disposed onto the surface, the first and second parts of the adhesive are configured to interact with each other on contact such that they securely bond together to secure the substrate to the surface, thereby securing the photovoltaic device against the surface. In another embodiment, the first and/or second parts of the adhesive include a configuration of microcapsules containing an adhesive or a portion thereof such that when the substrate is disposed over the structure, thereby sandwiching the first and second adhesive parts between them, the adhesive microcapsules fracture so its contents are activated in a manner to bond the substrate to the structure. The adhesive microcapsules can be held in a coating disposed over the substrate or the surface such that the contents within the microcapsule interact with the coating to form the bonding adhesive, or the coating can be configured for only holding the microcapsules and allowing the contents within the microcapsules to bond the substrate to the surface upon fracture, dissolve, of the microcapsules, In other embodiments, the adhesive parts, including microcapsules if desired, can be used between portions of the Photovoltaic device and the substrate.

In another embodiment, the first and second parts of the adhesive are activated to bond together when energy is applied to the area generally at or near the adhesive portion. The applied energy can be thermal energy, such as the application of heat at the area or cooling the area, for instance like the examples discussed hereinabove. In other instance, the installation is configured such that electrical energy is applied to the area to activate the first and second parts of the adhesive to bond together. In yet another example, a chemical is applied to the area to activate the first and second parts of the adhesive to bond together. It is to be noted that the bonded first and second parts of the adhesive are also configured to be non-destructively detachable, for example by utilizing the methods discussed hereinabove.

In another exemplary embodiment and referring to FIG. 3, a photovoltaic system 30 is illustrated. The installation system 30 includes one or more photovoltaic devices 32a, 32b, 32c, and 32d secured to an interface layer 34, a substrate 36 and a mounting system 38. In this embodiment, the interface layer 34 is disposed between the photovoltaic devices and the substrate 36. The mounting system 38 may be similar to the mounting system 20 of photovoltaic installation 10 and incorporate the alternative embodiments discussed above.

In certain embodiments, the interface layer aids in managing a characteristic of the photovoltaic installation for example, a thermal, chemical, electrical, combustible, insect control, etc. For instance, the interface layer provides a thermal barrier between the photovoltaic device and the surface. A locality may have a building code requirement for a structure to have a minimum amount of thermal resistance (R-value). An interface layer with a high R-value insulates more compared to a layer with a lower R-value. In another embodiment, a polyurethane interface layer is disposed between the substrate and the surface.

In another embodiment, the interface layer may be configured to protect the surface and/or the substrate and photovoltaic devices from moisture. In another instance, the interface layer may be configured to provide protection from insects. And in yet another embodiment, the interface layer may be configured to provide a flame-barrier, with a fire rating or classification, between the photovoltaic devices and the surface such that a flame is slowed or prevented from crossing the barrier.

In another embodiment, the interface layer is a coating applied to the surface where the inactive area or the substrate is detachably secured to the coating. In yet another embodiment, the interface layer is a coating that is applied to the unexposed side of the inactive area, substrate, or intermediate layer, wherein the adhesive portions are then attached to the coating. In such an embodiment, the adhesive portion is removable, but a portion of the coating may also be removed from inactive area, substrate, or intermediate layer without degrading the photovoltaic devices to render them inoperable.

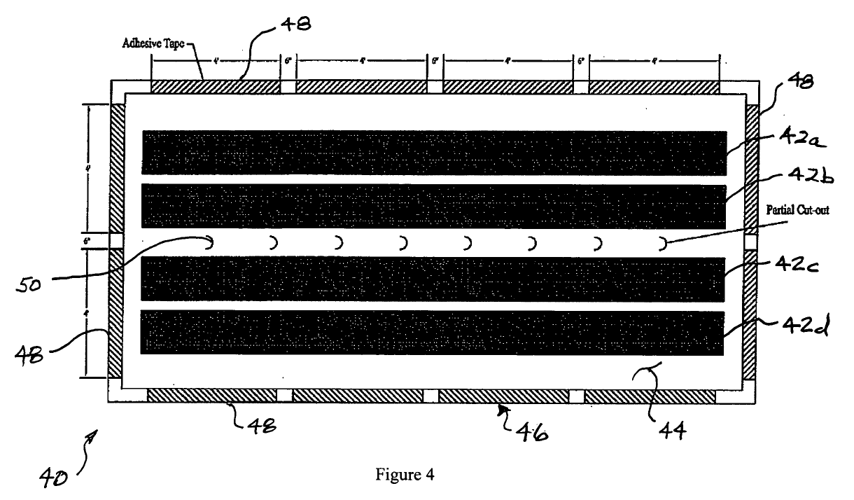

Referring to FIG. 4, a photovoltaic installation system 40 is illustrated in accordance with another exemplary embodiment of the present invention. The installation system 40 includes spaced photovoltaic devices 42a, 42b, 42c, and 42d secured to a substrate 44, and a mounting system 46. In this embodiment, the mounting system 46 includes a plurality of spaced adhesive portions 48, wherein the adhesive portions secure the substrate 44 to a surface of a structure. The adhesive portions are each configured so a portion of the substrate is non-destructively detachable from the surface and the photovoltaic devices are not made incapable of operation due the detachment process.

The adhesive portions and their arrangement can be configured to satisfy a particular environment, the configuration of the structure, a building code requirement particular to the location, load conditions, etc, for securing the photovoltaic devices against the surface. In certain embodiments, the adhesive portions have a unique configuration to maintain the substrate and the photovoltaic devices against the surface during a predetermined load condition. For example and in one embodiment, a specific number of adhesive portions, each having substantially the same surface area and composition, are selected to maintain the substrate and the photovoltaic devices against the surface during a predetermined wind uplift condition. In another embodiment, a certain number of adhesive portions have a unique composition, contact surface area with the substrate, and/or orientation with respect to the photovoltaic installation and structure compared to the remaining adhesive portions utilized to maintain the substrate and the photovoltaic devices against the surface. In another embodiment, a double row of adhesive portions are positioned at one or more locations along the substrate for securing the substrate and the photovoltaic devices against the surface.

In an embodiment, if it is determined or a building code dictates that high winds prevail from a northerly direction, then a greater number of adhesive portions can be positioned at that portion of the installation near the northern direction, compared to the remaining adhesive portions utilized to secure the substrate to the surface. Additionally, a subset of adhesive portions can also have a higher strength composition, a different spacing between adhesive portions, and/or a larger contact surface area positioned near the location of higher loads compared to the remaining adhesive portions. In another embodiment, a double-row of spaced adhesive portions is positioned near the location of high loading, whereas a single row of spaced adhesive portions is utilized at the other areas of the installation between the substrate and the surface. Of course in another embodiment, at least a double-row of adhesive portions is used uniformly about the perimeter of the photovoltaic device installation with or without adhesive portions at other interior positions of the installation.

In another alternative embodiment, the substrate 44 includes a plurality of spaced cutouts 50, as shown in FIG. 4. The cutouts can aid to reduce pressure that tends to lift the photovoltaic device installation from the surface, say for example, when the installation is subjected to high wind load conditions. In another application, the cutouts may help to reduce substrate degradation due to material stresses during an installation condition, for example, from over stretching a portion of the substrate. In another application, the cutouts may help to reduce substrate degradation due to material stresses that occur after installation, for example, from thermal cycling. Of course, the number of cutouts utilized will depend on the specific environment, installation configuration, load conditions, etc. that the installation is designed to accommodate. And in yet another alternative embodiment, the installation system may incorporate with the membrane a pressure equalization valve to offset a detrimental effect associated with a wind uplift load condition.

Of course, alternative embodiments of the installation system 40 may include substrate or membrane materials discussed hereinabove with respect to the installation system 10 of FIG. 1 and may also utilize an interface layer as discussed with respect to the installation system 30 of FIG. 3. Additionally, in other embodiments, the substrate, inactive layer or other intermediate layer may include portions structurally reinforced or otherwise modified to accommodate mounting members (like the adhesive portions), electrical components, fastening components, valves and other system components.

In other photovoltaic device installations it may be desirable to utilize a mounting system that includes detachable mounting members or ballast members to secure the photovoltaic device against the surface. The ballast members and their arrangement can be configured to satisfy a particular environment, the configuration of the structure, a building code requirement particular to the location, load conditions, etc. for securing the photovoltaic device against the surface. For example, a ballast member can have a configuration with a unique material, shape, size and a mass to suit the application. Some non-limiting examples are: low profile elongated high-mass members, circular shapes, blocks, two-piece members having a lower mass portion over a high-mass portion, and perforated members.

In certain embodiments, the mounting system utilizes ballast members configured to secure a photovoltaic device against a surface having a substantially horizontal orientation or a slope so that the photovoltaic device installation or a component thereof does not displace due to the affect of gravity.

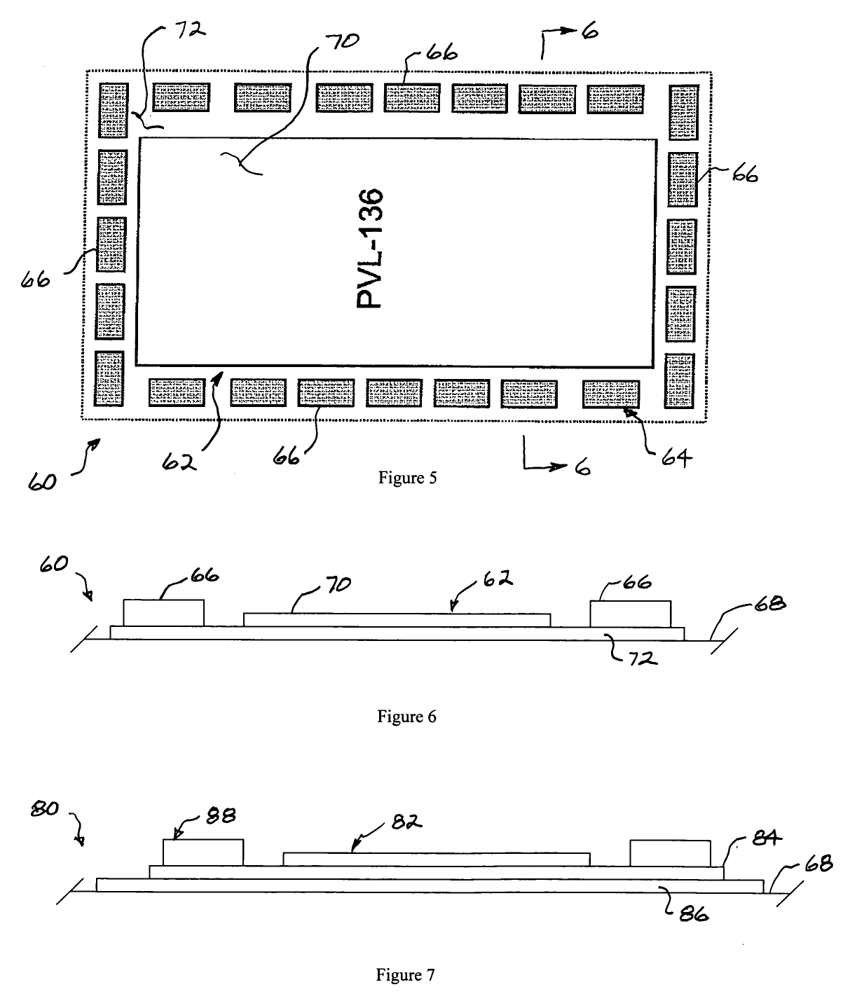

Referring to FIG. 5, a photovoltaic installation system 60 is illustrated in accordance with an exemplary embodiment of the present disclosure. The installation system 60 includes a photovoltaic device 62 and a mounting system 64. In this embodiment, the mounting system 64 includes of a plurality of spaced ballast members 66. The ballast members are configured to detachably secure the photovoltaic device 62 against a surface 68 as shown in FIG. 6. The surface can, for example, be a building surface like a roof surface or a cover for a structure as discussed hereinabove.

In this embodiment, the photovoltaic device 62 includes an active area 70 and an inactive area 72 joined together. The active area is the region of the photovoltaic device that is configured for converting incident light into electricity. For example, the active area 70 may include a thin-film double or triple-junction solar cell construction. The inactive area 72 is the region of the photovoltaic device that is not utilized to convert incident light into electricity. In an exemplary embodiment, the photovoltaic device is manufactured so that the inactive area is not a separate member but is an integral portion extending from the active area.

In one embodiment, the inactive area has a thin film construction of similar materials that extends in a direction away from the active area. In another embodiment, the inactive area is constructed of a material different from the active area. In another embodiment, the inactive area has a different thickness than the active area. In other embodiments, portions of the inactive area are structurally reinforced or otherwise modified to accommodate the ballast members or fastening components utilized for detachably securing the ballast members. Additionally, in certain embodiments the inactive area may include cutouts as discussed hereinabove with respect the installation system 40 of FIG. 4.

The ballast members 66 are configured to be quickly and fixedly secured to the inactive area of the photovoltaic device to urge the inactive area (and the joined active area of the photovoltaic device) against the surface. Additionally, the ballast members are configured so they can be quickly and easily detached from the inactive area in a non-destructive manner and the photovoltaic device is not made inoperable due the detachment process. In exemplary embodiments, the ballast members and the inactive area are configured so that a minimum number of tools are utilized for assembly or removal of the ballast members with the inactive area.

In one embodiment, the ballast members and the inactive area are configured so that no tools are required to secure the two together or to non-destructively detach the ballast members from the inactive area. In some embodiments, the photovoltaic device can be secured against the surface and later detached from the surface in a non-destructive manner so as to not degrade the inactive area. In other instances, a portion of the inactive area, substrate or intermediate layer may degrade due to the detachment of a ballast member, but shall not degrade to the degree that the photovoltaic device becomes inoperable, at the next installation, due to the detachment process. The ballast members and their fixation configuration are such that severing or puncturing the inactive area, substrate, or intermediate layer will not be required for detachment of the ballast members.

In one embodiment, at least one of the ballast members 66 is detachably secured to the inactive area 72 by an adhesive such as cold-bonded adhesive. In an alternative embodiment, at least one of the ballast members is detachably secured to the inactive area utilizing a hook and loop fastening device. In another alternative embodiment, at least one of the ballast members is secured to the inactive area utilizing a threaded fastener. For example, the fastener may be a threaded bolt with a flat head positioned at the bottom side (non-exposed side) of the inactive area where the threaded portion of the bolt extends through the thickness of the inactive area material and into or through the ballast member disposed on the exposed side of the inactive area.

In certain embodiments, the number of ballast members, their configuration and/or arrangement is selected to withstand certain conditions at the location of the photovoltaic device installation such as but not limited to wind loads, jarring movements, and environment elements. For instance, in certain embodiments the ballast members have a unique configuration to maintain the photovoltaic device against the surface during a single predetermined load condition.

For example and in one embodiment, a certain number of ballast members, each having a substantially similar configuration, is arranged along the inactive area to maintain the inactive area and the photovoltaic device against the surface during a predetermined wind uplift condition at a geographic location. In another embodiment, a certain number of ballast members have a unique configuration and/or a contact surface area with the inactive area, or orientation with respect to the photovoltaic device installation and structure compared to the remaining ballast members utilized to maintain the inactive area of the photovoltaic device against the surface. In another embodiment, a double-row or more of spaced ballast members is positioned near the location of high loading, whereas a single row of spaced ballast members may be utilized at another other area of the installation that may not experience the high loading as the area where the double-row of ballast members are located.

In another embodiment, a surface of the ballast member that contacts the inactive area includes a texture such that movement of the ballast member along the inactive area is impeded when the ballast member is placed against the inactive area. And in another embodiment, a surface of the inactive area can have a texture that impedes movement of a contacting ballast member along the inactive area. Of course, both the ballast member and the inactive area can have contacting textured surfaces to impede movement of the ballast member along the inactive area.

In another exemplary embodiment and referring to FIG. 7, a photovoltaic system 80 is illustrated. The installation system 80 includes a photovoltaic device 82 secured to an interface layer 84, a substrate 86, and a mounting system 88 having a plurality of spaced mounting or ballast members. In this embodiment, the interface layer 84 is disposed between the photovoltaic device 82 and the substrate 86. The interface layer 84 is substantially similar to the interface layer 34 of the installation system 30 of FIG. 3 and may have alternative forms as discussed hereinabove with respect to interface layer 34. Of course, in alternative embodiments, substrate 86 may have alternative forms as discussed hereinabove with respect to the substrate 14 of the installation system 10 of FIG. 1. The mounting system 88 may be similar to the mounting system 64 of photovoltaic installation 60 and/or incorporate the alternative embodiments discussed above.

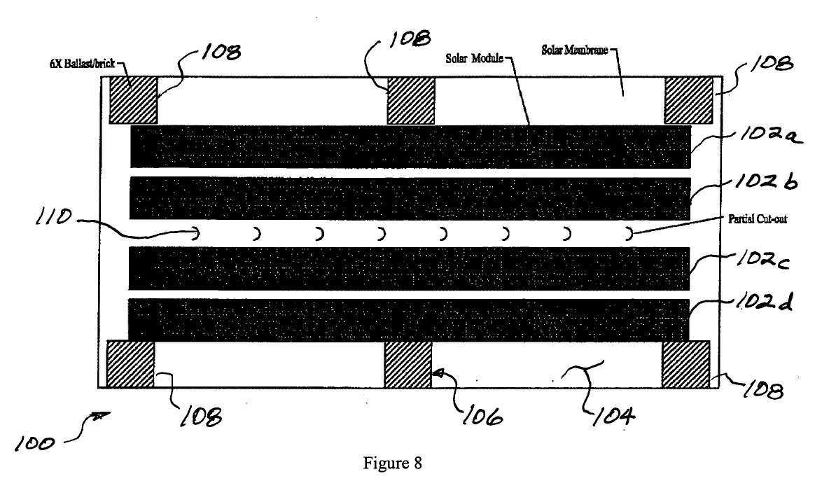

Referring to FIG. 8, a photovoltaic installation system 100 is illustrated in accordance with yet another exemplary embodiment. The installation system 100 includes a plurality of spaced photovoltaic devices 102a, 102b, 102c, and 102d, a substrate 104, and a mounting system 106. In this embodiment, the mounting system 106 includes of a plurality of spaced ballast members 108. The ballast members are configured to secure the substrate 104 (with the photovoltaic devices secured thereto) against a surface. The ballast members are further configured to be non-destructively detachable from the substrate and the photovoltaic devices are not made inoperable due to the detachment process. In this embodiment, the substrate 104 also includes a plurality of spaced cutouts 110 whose purpose is substantially similar to the cutouts 50 of the installation system 40 of FIG. 4 as discussed hereinabove.

In other alternative embodiments, the ballast members are secured to the inactive area of the photovoltaic device or to an intermediate layer or substrate utilizing a ballast member cover. In such embodiments, the ballast members are merely placed on an exposed area of the inactive area or the substrate and detachably held in position via the cover. The cover is disposed over the ballast member in contact with the inactive area or the substrate. In certain embodiments, the cover is a separate component to be disposed over the ballast member and detachably affixed to the inactive area or to the substrate. In an alternative embodiment, the cover is an integral portion of the inactive area or the substrate.

In such embodiments, the ballast member cover includes a cover fixation member configured to be detachably secured to a complimentary fixation member of the inactive area or the substrate. In certain applications, an arrangement of ballast members utilizing fixation members may have a unique configuration to suit the application similar to the discussion above with respect to unique configurations of adhesive portions and ballast members to suit a particular environment and/or load condition. In one exemplary embodiment, while the ballast members may be substantially similar, a certain number of the covers/fixation members may have a higher strength configuration for securing ballast members at a location of the installation subjected to higher loads compared to the remaining ballast members at another location of the installation.

In embodiments contemplated herein, the fixation members can have various configurations, such as degradable/removable adhesives, hook and loop fastening devices, snap-fit components, or slide and lock type mechanisms. Hook and loop fasteners include metallic, plastic type mechanical components or a Velcro product as supplied by Velcro USA, headquartered in Manchester, N.H. In other embodiments, the intermediate layer, inactive area, substrate, or the interface layer include portions structurally reinforced or otherwise modified to accommodate the fixation members at a location.

In yet another alternative embodiment, the ballast members themselves may have a configuration where a ballast fixation member is an integral portion of the ballast member configured to be detachably secured to a complimentary fixation member of the inactive area or the substrate. For instance the ballast members may have integral fastening members such as adhesives, hook and loop fastening devices, snap-fit components, or slide and lock type mechanisms. In another alternative embodiment, a ballast fixation member is a cover where the cover has a cover fixation member that engages a complimentary substrate fixation member.

In another example, a ballast member includes a snap-fit male portion that forcibly engages a complementary female portion to thereby detachably secure the ballast member against the substrate. In another example, a component joined to the ballast fixation member slidably engages a complementary substrate fixation member and incorporates an engagement lock that detachably secures the ballast fixation member with the substrate fixation member, to detachably secure the ballast member against the substrate. In some embodiments, the detachable engagement locking mechanism operates in a manner similar to a seat belt buckle. In alternative embodiments, a ballast member cover may be used, in addition to fixation members, to secure the ballast member to the inactive area or to the substrate.

It is also contemplated that in certain applications, a mounting system includes a combination of adhesive portions and ballast members utilized to detachably secure a photovoltaic device to a surface. Further, in other applications where the photovoltaic device is being relocated from one location to another having a different environment condition and/or structure, it may be desirable to change the prior mounting system to a different mounting system to accommodate the new installation. It is intended herein that the adhesive portion configurations and certain embodiments of ballast member configurations can be non-destructively removed from the attached components so a new configuration of mounting system can be utilized with the relocated photovoltaic devices to suit the new installation.

It is also contemplated in another embodiment, a photovoltaic device is non-destructively attached over a substrate that is disposed over an irregular surface, such as but not limited to, like gravel, dirt, grass, etc. The attachment methods include those methods discussed hereinabove concerning application of adhesives and/or ballast members.

In a further alternative embodiment, spaced ballast members are merely placed atop an exposed area of the inactive area of the photovoltaic device or the substrate to urge the photovoltaic device against the surface. In this embodiment, the ballast members are not fixed to the inactive area but urge the inactive area against the mounting surface due to the mass of the ballast members. In an exemplary embodiment, the ballast members are perforated to reduce surface area subjected, for example, to a wind load so the ballast members maintain the inactive area or the substrate against the surface. The ballast members may also be aerodynamically configured so a wind load is less likely to displace the ballast members. For example, a ballast member may include a rounded or a tapered portion or the like to reduce the chance the ballast member is displaced due to a wind load. In another alternative embodiment, the spaced ballast members can be coupled together with a connecting member, e.g. cable or rod, extending through the perforated portions. In this embodiment, any one ballast member is less likely to move a great distance relative to the other ballast members when they are subjected to a high wind load.

In yet another alternative embodiment, the ballast members also have a means for inserting and removing a ballast material. For example, the ballast members can have a filling and a drain port, or a detachable portion for filling and later removing the ballast material. Ballast members having this configuration may have utility and flexibility in selecting and changing the ballast material to suit a particular environment and/or load condition where the photovoltaic device is to be installed. The configuration of ballast members just discussed also provides benefit in not having to transport heavy ballast members.

In certain embodiments, the freely spaced ballast members can be configured so that a first portion of the ballast members is configured and positioned to maintain a portion of the photovoltaic device against the surface during an environmental condition, such as a high wind load or a jarring load. A second portion of the ballast members has a different configuration and positioning to maintain another portion of the photovoltaic device against the surface during a load condition different than the first portion of ballast members experience. Of course, a photovoltaic device installation utilizing freely spaced ballast members can include one or more layers as discussed hereinabove such as an intermediate layer, membrane, or an interface layer.

It is further contemplated that embodiments discussed herein can also be configured to conform to specifications set by an organization such as Underwriters Laboratory or Factory Mutual (UL/FM). For example, the photovoltaic device installation, including a non-destructively detachable mounting system, satisfies certain organizational requirements directed to material, dimensional, weight, strength, electrical, fire/flame, insect, rodent, etc. specifications.

While the foregoing description has been directed to certain embodiments of photovoltaic device installations utilizing non-destructively detachable mounting systems for securing the photovoltaic device, the principles of this invention are applicable to other embodiments of photovoltaic device installations not disclosed herein. In view of the teachings presented herein, yet other modifications and variations of the invention will be apparent to those of skill in the art. The foregoing is illustrative of particular embodiments, but is not meant to be a limitation upon the practice thereof. It is the following claims, including all equivalents, which define the scope of the invention.

What is claimed is:

1. A mounting system for securing a photovoltaic device against a surface, the mounting system comprising a mounting member for securing an inactive area of the photovoltaic device to the surface, the mounting member being configured so the inactive area is non-destructively detachable from the surface and the photovoltaic device is not made incapable of operation due the detachment process.

2. The mounting system of claim 1, wherein the surface is a planar surface.

3. The mounting system of claim 1, wherein the mounting member utilizes an interference-fit engagement for securing the inactive area of the photovoltaic device to the surface.

4. The mounting system of claim 3, further comprising a plurality of mounting members spaced about the inactive area, at least two of which utilize an interference-fit engagement, each of the mounting members being configured so a portion of the inactive area is non-destructively detachable from the surface and the photovoltaic device is not made incapable of operation due the detachment process.

5. The mounting system of claim 4, wherein the mounting members have a configuration to secure the inactive area of the photovoltaic device to the surface during a predetermined load condition imposed on the photovoltaic device.

6. The mounting system of claim 4, further comprising a substrate that the photovoltaic device is secured thereto, wherein the mounting members are spaced about the substrate for securing the substrate to the surface, each of the mounting members being configured so a portion of the substrate is non-destructively detachable from the surface and the photovoltaic device is not made incapable of operation due the detachment process.

7. The mounting system of claim 6, further comprising an interface layer disposed between the photovoltaic device and the substrate.

8. The mounting system of claim 1, wherein the inactive area of the photovoltaic device further includes a cutout.

9. The mounting system of claim 1, wherein the mounting member is an adhesive portion.

10. The mounting system of claim 9, wherein the adhesive portion has a configuration to secure the inactive area of the photovoltaic device to the surface during a predetermined load condition imposed on the photovoltaic device.

11. The mounting system of claim 9, wherein the adhesive portion comprises a first part applied to the inactive area and a second part applied to the surface, wherein each of the first and second adhesive parts have a configuration such that bonding is activated during contact between the first and second parts of the adhesive portion.

12. The mounting system of claim 11, wherein each of the first and second adhesive parts have a configuration such that bonding is activated when energy is applied to the inactive area generally opposite the first adhesive part after contact between the first and second parts of the adhesive portion.

13. The mounting system of claim 9, wherein the adhesive portion has a configuration such that it is degraded by an application of energy to an area proximate the adhesive portion in order to non-destructively detach the inactive area from the surface.

14. The mounting system of claim 9, wherein the adhesive portion adhesive portion has a configuration such that it is degraded by an application of a solution to the adhesive portion in order to non-destructively detach the inactive area from the surface.

15. The mounting system of claim 9, further comprising a plurality of spaced adhesive portions for securing the inactive area to the surface, each of the adhesive portions being configured so a portion of the inactive area is non-destructively detachable from the surface and the photovoltaic device is not made incapable of operation due the detachment process.

16. The mounting system of claim 15, wherein the plurality of adhesive portions have a configuration to secure the inactive area of the photovoltaic device to the surface during a predetermined load condition imposed on the photovoltaic device.

17. The mounting system of claim 16, wherein the configuration of the adhesive portions includes a first set of adhesive portions having a first configuration and a second set of adhesive portions having a second configuration, the first configuration of adhesive portions secure a first portion of the inactive area to the surface during the predetermined load condition, the second configuration of adhesive portions secure a second portion of the inactive area to the surface during a load condition different from the predetermined load condition.

18. The mounting system of claim 15, further comprising a substrate that the photovoltaic device is secured thereto, wherein the adhesive portions are spaced about the substrate for securing the substrate to the surface, each of the adhesive portions being configured so a portion of the substrate is non-destructively detachable from the surface and the photovoltaic device is not made incapable of operation due the detachment process.

19. The mounting system of claim 18, wherein a configuration of the adhesive portions includes a first set of adhesive portions having a first configuration and a second set of adhesive portions having a second configuration, the first configuration of adhesive portions secure a first portion of the substrate to the surface during a predetermined load condition, the second configuration of adhesive portions secure a second portion of the substrate to the surface during a load condition different from the predetermined load condition.

20. The mounting system of claim 18, wherein a plurality of spaced photovoltaic devices are secured to the substrate.

21. The mounting system of claim 18, further comprising an interface layer disposed between the photovoltaic device and the substrate.

22. The mounting system of claim 18, wherein the substrate further includes a cutout.

23. A mounting system for securing a photovoltaic device against a surface, the mounting system comprising a plurality of spaced ballast members disposed on an inactive area of the photovoltaic device, wherein the ballast members urge the inactive area against the surface.

24. The mounting system of claim 23, wherein the surface is a planar surface.

25. The mounting system of claim 23, wherein the ballast members are perforated.

26. The mounting system of claim 25, wherein the spaced ballast members are coupled together with a connecting member utilizing a portion of the holes.

27. The mounting system of claim 23, further comprising a substrate that the photovoltaic device is secured thereto, the spaced ballast members being disposed on the substrate and the ballast members urge the substrate against the surface.

28. The mounting system of claim 27, wherein the ballast members are fixedly secured to the substrate, and each of the ballast members being configured to be non-destructively detachable from the substrate and the photovoltaic device is not made incapable of operation due the detachment process.

29. The mounting system of claim 28, wherein at least one of the ballast members is detachably secured to the substrate with an adhesive.

30. The mounting system of claim 28, wherein at least one of the ballast members is detachably secured to the substrate utilizing a hook and loop fastener.

31. The mounting system of claim 28, wherein at least one of the ballast members includes a ballast fixation member that engages a complementary substrate fixation member.

32. The mounting system of claim 31, wherein the ballast fixation member is one of a snap-fit, hoop and loop, or an engage-and-lock fastener.

33. The mounting system of claim 31, wherein the ballast fixation member is a cover disposed over the ballast member, the cover having a cover fixation member that engages the complementary substrate fixation member.

34. The mounting system of claim 33, wherein the cover is an integral part of the substrate.

35. The mounting system of claim 31, further comprising an interface layer disposed between the photovoltaic device and the substrate.

36. The mounting system of claim 31, wherein a configuration of the ballast members includes a first set of ballast members having a first configuration and a second set of ballast members having a second configuration, the first configuration of ballast members secure a first portion of the substrate to the surface during a predetermined load condition, the second configuration of ballast members secure a second portion of the substrate to the surface during a load condition different from the predetermined load condition.

37. A method of securing a photovoltaic device to a surface, the method comprising:
positioning a mounting member along an unexposed side of a substrate having the photovoltaic device secured to an exposed side of the substrate; and
securing the mounting member to the surface, the mounting member being configured so the substrate is non-destructively detachable from the surface and the photovoltaic device is not made incapable of operation due the detachment process.

38. The method of claim 37, wherein at least one of the mounting members comprises an adhesive portion or a snap-fit fastener.

39. The method of claim 38, wherein the adhesive portion comprises a first part applied to the substrate and a second part applied to the surface, wherein the first and second adhesive parts have a configuration such that bonding is activated during contact between the first and second parts of the adhesive portion.

40. The method of claim 39, wherein the adhesive portion has a configuration such that it is degraded by an application of energy to an area proximate the adhesive portion in order to non-destructively detach the substrate from the surface.

41. The method of claim 37, further comprising the step of disposing an interface layer between the photovoltaic device and the substrate.
